(19) United States
(12) Patent Application Publication
(10) Pub. No.: US 2004/0060137 A1
(43) Pub. Date: Apr. 1, 2004

(54) Toothbrush with sectorial motion

(76) Inventor: Eyal Eliav, New York, NY (US)

Correspondence Address: FROMMER LAWRENCE & HAUG, 745 FIFTH AVENUE- 10TH FL., NEW YORK, NY, 10151, US

(21) Appl. No.: 10/260,669

(22) Filed: Sep. 27, 2002

(51) Int. Cl. A61C 17/34

(52) U.S. Cl. 15/22.1; 15/22.4; 15/28; 601/142

(57) ABSTRACT

A powered toothbrush to provide oral hygiene having a brush section with a first bristle carrier that is powered and driven to rotate in an oscillating manner through a prescribed angle. A second bristle carrier is pivotally connected to the first bristle carrier and also pivotally connected to the brush section. The second bristle carrier oscillates in accordance with the oscillation of the first bristle carrier in a sectorial manner. The bristle carriers may include a variety of elastomeric and non-elastomeric bristles or combinations thereof to provide cleaning, polishing, whitening and stimulating to the teeth and gums.

### BACKGROUND OF THE INVENTION

1. Field of the Invention

The present invention relates generally to powered oral care products, and more specifically, powered toothbrushes that have distinct head sections.

2. Description of the Related Art

Toothbrushes provide many oral hygiene benefits. For example, toothbrushes remove plaque and food debris to help avoid tooth decay and disease. They also remove stained pellicle from the surface of each tooth helping whiten the teeth. Also, the bristles combined with the brushing motion massage the gingival tissue for stimulation and increased health of the tissue.

Powered toothbrushes have been available for some time. Powered toothbrushes have advantages over manual (non-powered) toothbrushes by imparting movement to the bristles at much higher speeds as well as imparting different types and directions of motion to the bristles than possible with manual tooth brushes. These motions, generally in combination with manual movement of the toothbrush by the user, provide superior cleaning than manual toothbrushes.

Typically, powered toothbrushes are powered by disposable or rechargeable batteries that power an electric motor that in turn drives the toothbrush head. Known powered toothbrushes also typically include a brush head with a bristle carrier portion that rotates, oscillates or vibrates in some manner so as to clean the teeth. The bristles, which typically comprise bristle tufts, are generally uniform with one end fixed into the bristle carrier portion and the other end free to contact the surface of the teeth while brushing. The free ends of the various tufts present a surface envelope that is capable of some deformation when the bristles bend so that the surface envelope tends to conform to the complex surface of the teeth. Human teeth generally lie in a “C” shaped curve within the upper and lower jaws. Individual teeth often have extremely complex surfaces, with areas that may be flat, concave, or convex. The more precise conformation between the bristles and the tooth surface, the more effective the toothbrush may be in cleaning, whitening, and stimulating.

Known powered toothbrushes typically arrange the bristles in a compact conical or cylindrical pattern on a generally circular, disk-shaped bristle carrier. The powered toothbrush heads are traditionally compact, generally oval in shape and the heads are produced with a flat trimmed bristle pattern. Alternatively, other head shapes and bristle patterns are available.

One example of a powered toothbrush known in the art is illustrated in U.S. Pat. No. 5,625,916 to McDougall, which is hereby incorporated by reference in its entirety. The toothbrush shown in McDougall has a disc-shaped bristle carrier. The bristle carrier, and thus the bristles, are driven in a vibrating or oscillating manner, which may be illustrated by reference to FIGS. 1A-1C. A toothbrush 5 comprises a handle portion 10 at proximal end of the toothbrush 5, and a head 11 at a distal end of the toothbrush 5. The handle portion 10 has compartments for containing a powered motor 14 and batteries 15 and 16. The head 11 includes a generally circular bristle holder 13. A rotatable shaft 12 extends from the motor 14 to the head 11. A shaft coupling 17 may be located along the shaft 12 and configured so that the shaft 12 may be separated at a point between the motor 14 and the head 11. This permits the removal of the head 11 from the toothbrush 5 for cleaning or replacement.

The head 11 includes a post 18 that provides a rotational pivot axis for the bristle holder 13 containing bristles 19. The distal end of the shaft 12 has a journal or offset 20 that is radially displaced from the longitudinal axis of the shaft 12. The bristle holder 13 has a slot 22 that receives the offset 20. The offset 20 and the slot 22 are configured so as to be oriented toward the intersection of the shaft 12 axis and the longitudinal axis of the post 18. When the motor 14 rotates the shaft 12, the motion of the offset 20 defines a circle about the shaft 12 axis and drivingly engages the slot 22 such that the bristle holder 13 vibrates or oscillates about the post 18 axis through a rotational angle A. The rotational angle A is defined by the displacement of the offset 20 from the shaft 12 axis relative to the diameter of the bristle holder 13.

Powered toothbrushes such as described immediately above provide advantages over manual toothbrushes, but are subject to various limitations because of the relatively small head size. Providing a rotating or oscillating bristle holder with a typical oblong or oval toothbrush head constrains the size of the moving bristle holder, and thus limiting the area of bristles available for teeth cleaning. Also, when the bristles are placed in contact with the teeth during brushing, there is less bristle contact with adjacent areas, such as the gums, resulting in minimal stimulation of the gingival tissue.

One attempt to overcome the limitations of a small powered bristle area is shown in U.S. Pat. No. 6,000,083 to Blaustein et al. The toothbrush in Blaustein et al. has a bristle area and pattern similar to a manual toothbrush, wherein an area of the bristles has simply been replaced by a powered bristle section resulting in a head with a powered or moving bristle section and static bristle section. The static bristle section of Blaustein et al. provides no better cleaning, whitening or stimulation than a manual toothbrush.

International Application No. PCT/EPO1/07615 of Braun GmbH discloses a powered toothbrush with two separate, movable bristle sections. Each bristle section may have a different range and type of motion. The toothbrush of Braun, however, discloses only one powered bristle section. The other unpowered bristle section moves due to a resonance effect imparted by the frequency of the movement of the first bristle section.

This free resonance presents a number of difficulties. First, because any contact between the bristle parts will dampen or cancel any resonance of the unpowered bristle part, the unpowered bristle section “floats” separately from the powered bristle section and the rest of the toothbrush head. This necessitates separation or gaps between them. These gaps expose the internal workings of the head to foreign matter such as water, saliva, toothpaste, and food particles. This foreign matter may interfere with the workings of the unpowered bristle head. For example, the unpowered bristle part is spring-loaded to assist its resonance. Foreign matter may accumulate on or around the spring, interfering with its function. In addition, food particles may remain in the head and may fester and host microorganisms, which are undesirable if not potentially harmful when introduced directly into the mouth.

Another limitation of such a design is that movement of the unpowered bristle section may be damped by contact with the teeth, or lessened when the frequency of the powered section shifts from the resonance frequency. This can occur due to pressure imparted against the powered bristle section by the teeth or gums during brushing. An additional limitation is that the energy imparted to the unpowered bristle section is only a portion of the energy input into the powered section. Therefore, the unpowered bristle section is less effective in cleaning than the powered section, limiting the overall effectiveness of the toothbrush.

Thus, there is a need in the art for a powered toothbrush with increased effectiveness through a larger area of powered or driven bristles than known powered toothbrushes. There is also a need for a toothbrush having increased whitening and stimulation than known toothbrushes. There is a further need for such improved toothbrushes to be comparable in manufacturing and purchasing costs as known powered toothbrushes.

### OBJECTS OF THE INVENTION

It is a general object of the present invention to provide a powered toothbrush which avoids the aforementioned deficiencies and limitation of the known related art.

It is also an object of the present invention to provide a powered toothbrush which enhances the cleaning effectiveness of the toothbrush head.

It is a further object of the present invention to provide a powered toothbrush which enhances the whitening effectiveness of the toothbrush head.

It is yet another object of the present invention to provide a powered toothbrush which enhances the stimulating effectiveness of the toothbrush head.

It is still a further object of the present invention to provide a powered toothbrush which includes two separate, movable bristle sections or tuft blocks.

It is yet still a further object of the present invention to provide a powered toothbrush which includes a powered, rotationally-oscillating first bristle section and a second movable bristle section pivotally connected to the first bristle section and pivotally connected to the brush section.

It is also an object of the present invention to provide a powered toothbrush which includes a powered, rotationally-oscillating first bristle section and a second movable bristle section that is pivotally connected to the first bristle section and pivotally connected to the brush section, and that is capable of movement in a second a second degree of motion.

Various other objects, advantages and features of the present invention will become readily apparent from the ensuing detailed description and the novel features will be particularly pointed out in the appended claims.

### SUMMARY OF THE INVENTION

The present invention includes a powered toothbrush having at least two moving bristle fields in a brush section to provide increased moving bristle area and improved cleaning, polishing, whitening, massaging and stimulating of teeth and gums. The first bristle field includes a plurality of bristles attached to a first bristle carrier that is powered and driven in an oscillating rotational manner through a prescribed angle. The second bristle field includes a plurality of bristles attached to a second bristle carrier. The second bristle carrier is pivotally connected to the first bristle carrier and also pivotally connected to the brush section. The second bristle carrier is otherwise free from the brush section. The bristles in both the first and second bristle field may by any type of elastomeric or non-elastomeric bristles or any combination thereof.

The oscillating motion of the first bristle carrier imparts an according oscillating motion to the second bristle carrier such that the first and second bristle fields oscillate in a sectorial motion. The connections between the second bristle carrier and the first bristle, carrier and the brush section may be sufficiently flexible or otherwise configured so that they permit adequate pivoting of the second bristle carrier relative thereto. The second bristle carrier may be suspended from the brush section to avoid frictional contact therewith. Curtains or walls extending from the brush section to the second bristle carrier may be included to help prevent any debris, toothpaste or other objects from entering any gap therebetween.

The second bristle carrier may also be oscillatingly driven in a second degree of motion in addition to sectorial motion to provide additional bristle movement and effectiveness. This motion may be equal to, or a multiple of, the frequency of oscillation of the first bristle carrier and the sectorial motion of the second bristle carrier, or may comprise a complex oscillatory motion.

Other features and advantages of the present invention will be apparent from the foregoing detailed description when read in conjunction with the accompanying drawings.

### BRIEF DESCRIPTION OF THE DRAWINGS

The foregoing and other features of the present invention will be more readily apparent from the following detailed description and drawings of illustrative embodiments of the invention in which:

FIG. 1A is a front cross-sectional view of a related art powered toothbrush including a head;

FIG. 1B is a partial cross-sectional side view of the toothbrush head of FIG. 1A;

FIG. 1C is a partial cross-sectional front view of the toothbrush head of FIG. 1A;

FIG. 2 is a perspective view of a preferred embodiment of a powered toothbrush in accordance with the teachings of the present invention;

FIG. 3 is a front elevational view of a preferred embodiment of a toothbrush head to be used in conjunction with the toothbrush of FIG. 2;

FIG. 4 is a side elevational view of the toothbrush head of FIG. 3;

FIG. 5 is a perspective view of an elastomeric bristle adapted for use in a toothbrush head according to any of the present embodiments;

FIG. 6 is a perspective view of an elastomeric bristle adapted for use in a toothbrush head according to any of the preferred embodiments presented herein;

FIG. 7 is a perspective view of an elastomeric bristle adapted for use in a toothbrush head according to any of the preferred embodiments presented herein;

FIG. 8 is a perspective view of an elastomeric bristle adapted for use in a toothbrush head according to any of the preferred embodiments presented herein;

FIG. 9 is a perspective view of an elastomeric bristle adapted for use in a toothbrush head according to any of the preferred embodiments presented herein;

FIG. 10 is a front elevational view of the toothbrush head of FIG. 3 during an operational mode thereof;

FIG. 11 is a side partially broken away view of another preferred embodiment of a toothbrush head in accordance with the teachings of the present invention;

FIG. 12 is a cross-sectional view taken along the line 12-12 of FIG. 11;

FIG. 13 is a side partially broken away view of the toothbrush head of FIG. 11 to illustrate the toothbrush head during an operational mode thereof;

FIG. 14 is a front elevational view of yet another preferred embodiment of a toothbrush head in accordance with the teachings of the present invention;

FIG. 15 is a side elevational view of the toothbrush head of FIG. 14; and

FIG. 16 is a front elevational view of the toothbrush head of FIG. 14 during an operational mode thereof.

### DETAILED DESCRIPTION OF CERTAIN PREFERRED EMBODIMENTS OF THE PRESENT INVENTION

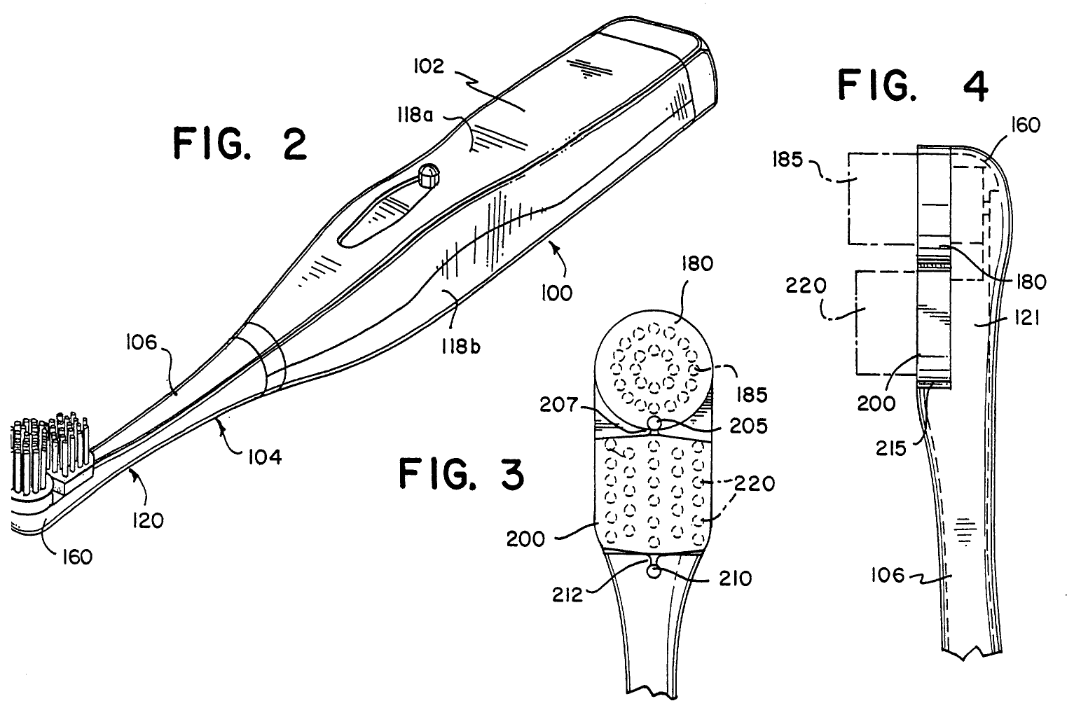

Referring to FIGS. 2-4, a toothbrush 100 includes a handle 102 at a proximal end thereof that defines an interior compartment (not shown) for housing various components and a brush section 104 having a neck 106 and a head 120 at a distal end of the toothbrush 100. The neck 106 defines an interior compartment (not shown) for housing various working components of the toothbrush 100. The head 120 is preferably generally aligned with the longitudinal axis of the toothbrush 100.

In a preferred embodiment, the brush section 104 is integrally formed with the handle 102. In an alternate embodiment, the brush section 104 may be detachably connected to the handle 102 at a location along the toothbrush. Those skilled in the art will appreciate the various manners in which this may be accomplished, e.g., friction fit, threaded connection, interlocking or bayonet fitting, etc. Detachability of the brush section 104 may enable desirable features of the toothbrush 100, for example, cleaning, servicing, and/or replacement of either the handle 102 or the brush section 104. It will be appreciated that in such embodiments the head 120 may thus be a refill head type.

It will further be appreciated that the illustrated shapes of the handle 102 and brush portion 104 are merely exemplary in nature and the handle 102 and/or neck 106 can be formed to have any number of shapes. The shapes of the handle 102 and the neck 106 may be of an aesthetic and/or ergonomic design such that the toothbrush 100 may be easily and comfortably gripped and manipulated by the user. The handle 102 may include slightly recessed finger sections 118a, 118b that are formed on opposite sides of the handle 102. One recessed finger section 118a may be designed to generally accommodate a thumb of one hand and other recessed finger sections 118b may be designed to generally accommodate one or more other fingers of the same hand, thereby assist the user in proper placement and secure grip of the toothbrush 100 in the user's hand. One or more of the recessed finger sections 118 may include ribs or other types of roughened surfaces to further assist gripping by the user. Such surfaces having acceptable frictional characteristics, e.g., rubber, are generally known in the art.

The toothbrush 100 according to the various embodiments disclosed herein can be made from any number of materials that are suitable for use in oral care products. For example, many of the components that are included in the toothbrush 100 are preferably formed from plastic materials. Accordingly, the handle 102, brush section 104 and/or head 120 may be molded from polyolefins such as polypropylenes and polyethylenes, polyamids such as nylons, and polyesters such as polyethylene terephthalate. Other suitable materials include polymethylmetllacrylate, styrene acroylonitrate and cellulose esters, for example cellulose propionate, and other materials known in the art.

The head 120 of the toothbrush 100 includes a head base 160 that at least partially defines an inner compartment 121 of the head 120. The head base 160 may be configured so that the distal end of the toothbrush 100 has a generally rounded shape for the comfort of the user during brushing.

The head 120 also includes a first movable bristle carrier 180, which in a preferred embodiment is located at or near the distal end of the head 120. Alternatively, the first bristle carrier 180 may be located at any location on the head 120.

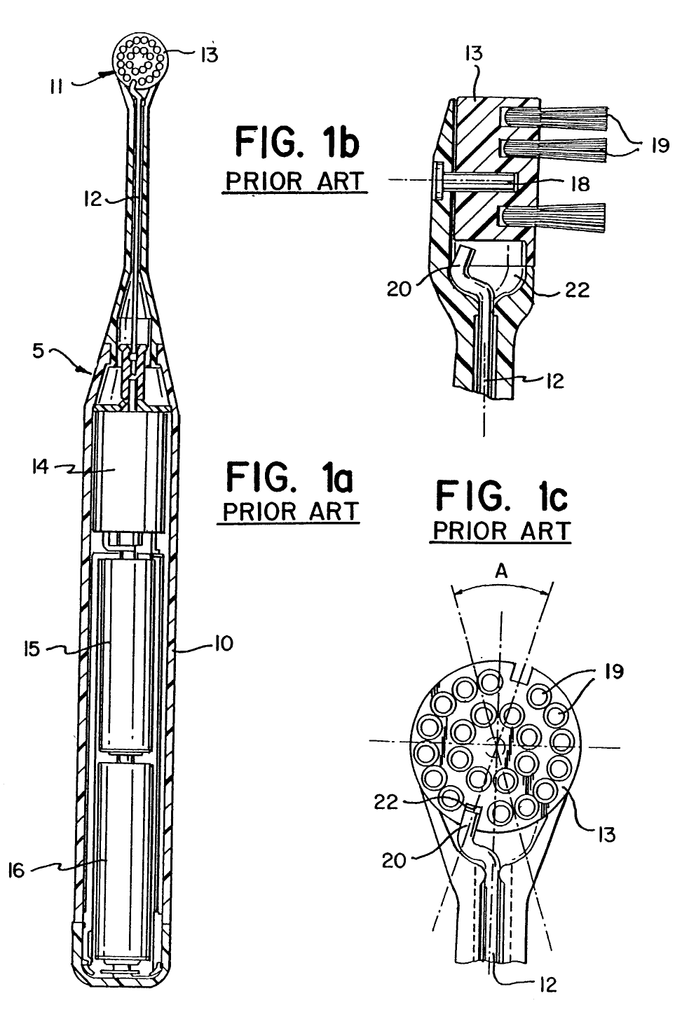

The first bristle carrier 180 is preferably configured such that it may be at least partially rotatable around an axis. In such embodiments, the first bristle carrier 180 may move in an oscillating or vibrating rotational manner. For example, the first bristle carrier may have an identical or similar construction to the bristle holder 12 illustrated in FIGS. 1A-1C. In such embodiments, the first movable bristle carrier 180 may be a circular disk. It will be appreciated that the first movable bristle carrier 180 is not limited to having a disk shape and may have any number of different shapes, e.g., oval, regular or irregular shapes, so long as the first bristle carrier 180 may oscillate in a rotational or vibrating manner.

The first bristle carrier 180 preferably includes a first plurality of bristles 185 coupled to and extending generally outwardly from the first bristle carrier 180. As used herein, the term “bristle” or “bristles” includes any type of structure that is suitable for providing oral health benefits (e.g., tooth cleaning, tooth polishing, tooth whitening, massaging, stimulating, etc.) during contact with surfaces of the teeth and gums. The bristles 185 preferably have a degree of flexibility so as to bend during brushing thus allowing the bristles 185 to conform to the surface and contours of the teeth and gums, thereby increasing bristle contact with the teeth and gum for improved effectiveness.

The bristles 185 may be composed of various materials including non-elastomeric materials or elastomeric materials. As used herein, the term “elastomeric” means that the material undergoes a relatively greater elongation under tensile force or stress, wherein the term “non-elastomeric” means that the material has a relatively lesser elongation under tensile force or stress. Examples of suitable generally non-elastomeric materials include, but are not limited to, polyamides such as nylon or polyesters such as polybutylene terephthalate. Examples of suitable generally elastomeric materials include, but are not limited to, rubbers (synthetic or natural) and block copolymers such as, e.g., styrenes (for example styrene ethylene butadiene styrene, or styrene butadiene styrene), polyolefins (for example polypropylene/ethylene propylene diamine modified systems (i.e. synthetic rubber)), polyamides (for example polyamide (2 or polyamide 6), polyesters (for example polyester ester or polyether ester), polyurethanes (for example polyesterurethane, polyetherurethane or polyesteretherurethane). For either non-elastomeric or elastomeric bristles, it is generally desirable that such materials are formed in a manner such that they are non-plastic and generally return to their original shape and size after brushing forces are removed.

Non-elastomeric bristles may be coupled to the head 120, e.g., the first bristle carrier 180, in the form of tufts. The bristles and/or tufts may be coupled by various means, such as stapling, may be molded (IMT) onto the head 120 during fabrication, or by other known means. Elastomeric bristles may be fabricated by known processes, such as molding, and coupled to the head by known means.

Although as shown in the Figures the bristles 185 have particular sizes, shapes, amounts, lengths, configurations, materials and/or combinations thereof, it should be appreciated that this is merely illustrative and that the bristles may be of any size, shape, amount, length, configuration, material and/or combination thereof suitable for oral hygiene to achieve specific results or operational characteristics of the bristles 185. By way of example, the bristles may be of different (non-uniform) lengths to form a particular surface envelope shape for improved effectiveness. This may also be done to accommodate differences between toothbrush users, including mouth size, teeth shape and contour, tooth and gum sensitivity, eating and other oral habits (e.g., smoking), and personal preferences.

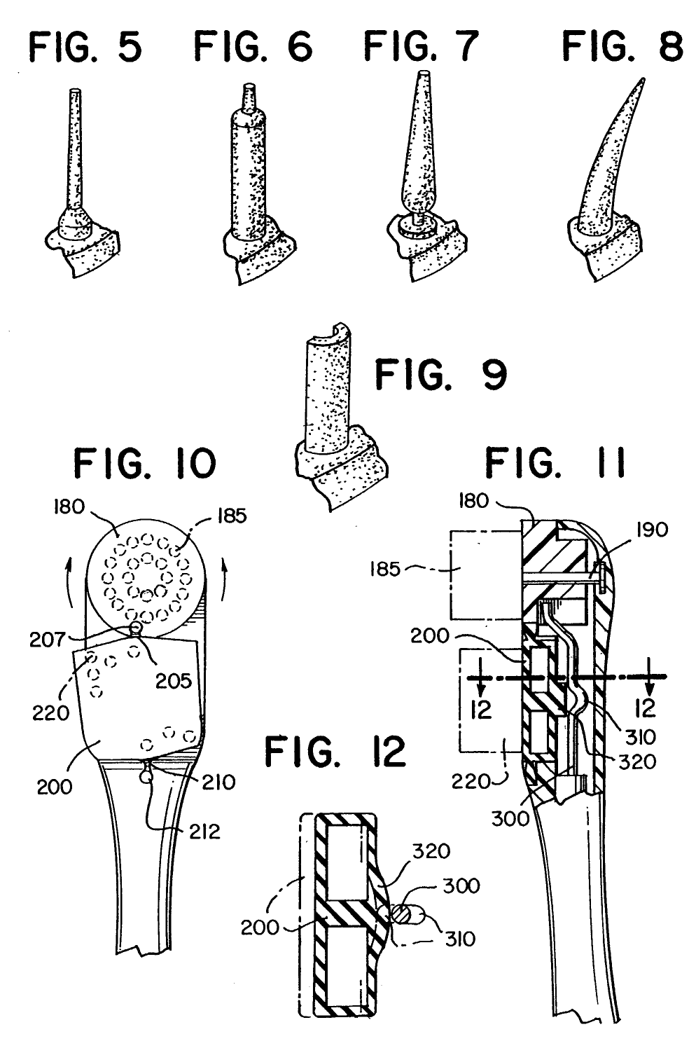

One desired characteristic of certain elastomeric bristles is the capability to be fabricated into various configurations. FIGS. 5-9 illustrate various embodiments of elastomeric bristles. FIG. 5 shows an elastomeric bristle in the form of a thin spike; FIG. 6 shows an elastomeric bristle in the form of a barrel spike; FIG. 7 shows an elastomeric bristle in the form of a squeegee point; FIG. 8 shows an elastomeric bristle in the form of an angled point; and FIG. 9 shows an elastomeric bristle in the form of a section of an elastomeric wall. An elastomeric wall as in FIG. 9 may have any number of shapes including but not limited to a linear, planar shape; a zigzag shape; or a serpentine shape. In the many contemplated embodiments the elastomeric bristles may have smooth or rough surface textures. In addition, the wall sections of the elastomeric bristles may be vertically straight, taper inward toward one end or expand toward one end. The tops of the elastomeric bristles may have a planar surface or can have a protrusion (i.e., bump). While the above describes various configurations of elastomeric bristles, those skilled in the art will recognize that virtually any configuration may be achieved.

Referring further to FIGS. 10 and 11, the first bristle carrier 180 may be adapted to be pivotally rotatable around an axis, thereby effectuating a rotational or circular movement of the bristles. In various embodiments, the first bristle carrier 180 may rotate around a post 190, although any suitable configuration that permits such movement may be used. The movement of the first bristle carrier 180 may be an oscillating or vibrational movement such that the first bristle carrier 180 first pivots about the post 190 in one direction through a range of motion and then pivots about the post 190 in the opposite direction through a range of motion.

An oscillating motion has advantages over known toothbrushes that continuously rotate in one direction in that the variation of direction and speed of the bristles during oscillation provides improved cleaning and stimulation. Although in an oscillating system of the invention the bristles may rotate through any range of motion, it has been found that ranges of motion from approximately 10° to 120° are effective in cleaning, whitening and stimulating. It has further been found that ranges of motion from approximately 10° to 30° are also effective, and further provide the benefits of reduced cost and complexity of the toothbrush drive mechanism.

The drive mechanism for the powered toothbrush 100 may be any type of drive, e.g., a rotating drive, an oscillating drive, an eccentric drive, an unbalanced-generated drive, a drive having one more gearing mechanisms, or any other type of drive mechanism that is capable of performing the intended function. The drive mechanism may be realized in the form of an electric motor or other type of motor and the movement generated by the drive may be imparted to one or more sections of the head 120 or to other elements that may be present at the brush section 104. The movement may be imparted directly or indirectly. Those skilled in the art will appreciate various suitable mechanisms.

One suitable mechanism is similar to the types described in U.S. Pat. No. 5,625,916 to McDougall, which has been previously incorporated herein, and in FIGS. 1A-1C. As described above, such a mechanism may be used to impart motion to the first bristle carrier. Those skilled in the art, however, will appreciate that variations in the details of the illustrated mechanism may be implemented as long as it performs its intended function.

In a preferred embodiment the toothbrush 100 further includes a second movable bristle carrier 200, which may be formed from any suitable material or materials, e.g., elastomeric and/or non-elastomeric as described above. The second bristle carrier 200 has a first pivot 205 that is pivotally connected to the first bristle carrier 180 at a first pivot mount 207 and a second pivot 210 that is pivotally connected to the brush section 104 at a second pivot mount 212. The second bristle carrier 200 is freely movable from the brush section 104 other than at the first pivot 205 and the second pivot 210 The oscillation of the first bristle carrier 180 preferably causes the second bristle carrier 200 to similarly oscillate, with the second bristle carrier 200 pivoting about the first pivot 205 relative to the first bristle carrier 180 and also pivoting about the second pivot 210 relative to the brush section 104. In this manner, the second bristle carrier 200 moves through an angular range of motion similar to that of the first bristle carrier 180. As the center of rotation of the second bristle carrier is the second pivot 210, the second bristle carrier 200 moves in a sectorial fashion.

The second bristle carrier 200 may reside in an indent 215 formed in the brush section 104 so that the second bristle carrier 200 is generally flush with or does not extend outwardly from the surface of the brush section 104 and/or the first bristle carrier 180. In such embodiments, the second bristle carrier 200 and the brush section 104 may be configured or shaped so that the second bristle carrier 200 does not impact the brush section 104 during oscillation.

In the embodiment illustrated in FIG. 3, the first and second pivot mounts 207, 212 comprise a notch in the first bristle carrier 180 and brush holder 104, respectively. The first and second pivots 205, 210 are adapted to engage into the first and second pivot mounts 207, 212 respectively, and preferably in a sufficiently secure manner so that the second bristle carrier 200 does not readily disengage from the toothbrush 100 during brushing. This may be accomplished by various methods, for example, by force fit, friction fit, snap fit, etc. Although in the illustrated embodiment the pivots 205, 210 fit into notches 207, 212, respectively, it should be recognized that the pivots and pivot mounts may be of any engaging configuration. For example, the pivots may be connected to the pivot mounts by pins (not shown) or other connectors.

The pivots 205, 210 are preferably adapted so that the second bristle carrier 200 may pivot relative to the first bristle carrier 180 and the brush section 104. This may be accomplished by various constructions. For example, the pivots 205, 210 may be sufficiently flexible, e.g., an elastomeric or flexible non-elastomeric material, so that it flexes or bends relative to the first bristle carrier 180 or brush section 104. In such embodiments, each pivot acts as a “living hinge.”

In other contemplated embodiments, the pivot itself need not be flexible if the pivot may rotate relative its respective pivot mount, such as in a “ball and socket” configuration. In another embodiment the pivot may be mounted to the pivot mount via a pin as discussed above. Those skilled in the art will recognize that there are other configurations that will achieve the intended function.

The second bristle carrier 200 includes a second plurality of bristles 220. The bristles 220 may be of any size, shape, amount, length, configuration, material and combinations thereof, as described previously regarding the first plurality of bristles 185. Accordingly, the written description above regarding the first plurality of bristles 185 is equally applicable to the second plurality of bristles 220, and is incorporated therefrom.

The sectorial oscillation of the second bristle carrier 200 moves the second plurality of bristles 220 in an accordingly sectorial oscillation. This oscillation, which in addition to the oscillation of the first plurality of bristles 185, provides additional powered bristle area and movement to clean, whiten and/or massage. In addition, as will be appreciated by those skilled in the art, in various embodiments the movement of the second plurality of bristles 220 differs from the movement of the first plurality of bristles 185, further enhancing the effectiveness of the toothbrush 100 through the combination of movement.

It should be appreciated that the bristles may be incorporated into the second bristle carrier 200 in any number of manners regardless of the material from which the second bristle carrier 200 is formed. By way of example, if the second bristle carrier 200 is formed from elastomeric material, elastomeric bristles may be incorporated during molding thereof. However, non-elastomeric bristles may be incorporated by including one or more inserts (not shown) having such bristles as previously described. The inserts may, for example, include plastic inserts having tufts of non-elastomeric bristles attached thereto.

Conversely, if the second bristle carrier 200 is formed from non-elastomeric material, e.g., plastic, non-elastomeric bristles may be attached thereto as described above. However, elastomeric bristles may be incorporated by including one or more inserts having elastomeric bristles in the second bristle carrier 200. Thus, the second bristle carrier 200 may include elastomeric bristles, non-elastomeric bristles, or any combination thereof. Those skilled in the art will recognize the multitude of possible bristle combinations and configurations.

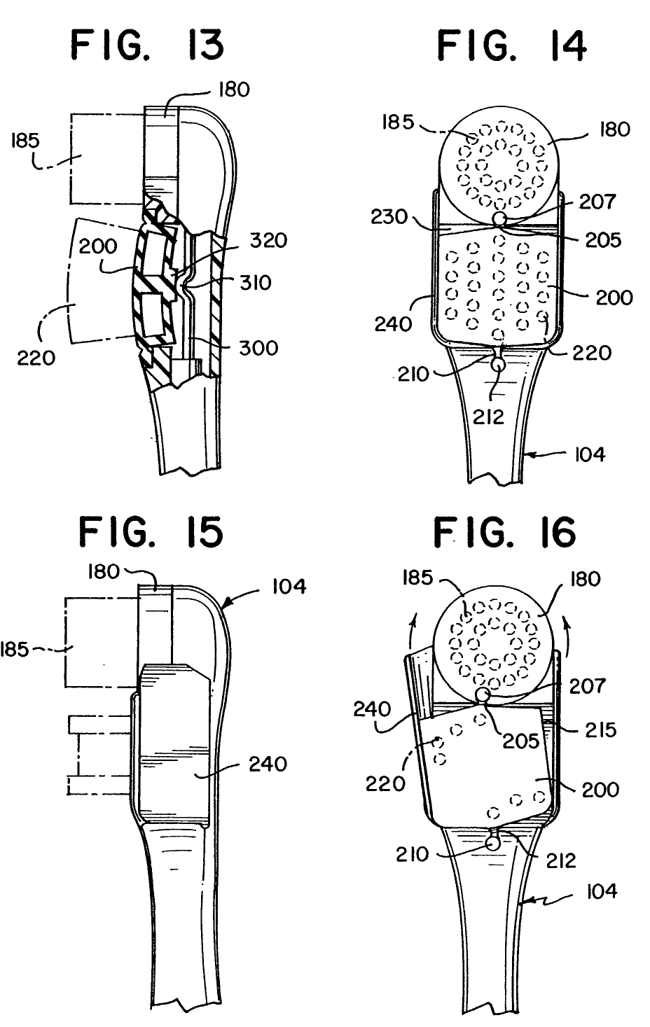

In yet further embodiments such as the one illustrated in FIGS. 11-13, the second bristle carrier 200 may additionally move in a generally vertical direction, i.e., radially inward and outward relative to the longitudinal axis of the toothbrush. Driveshaft 300, which may be similar to shaft 12 shown in FIGS. 1A-1C, preferably has at least one cam, detent, journal or offset 310 integral therewith that is generally longitudinally aligned with the second bristle carrier. The offset 310 preferably extends radially from the longitudinal axis of the driveshaft 300 such that during rotation of the driveshaft 300 the offset 310 contacts the second bristle carrier 200. The contact between the offset 310 and the second bristle carrier 200 exerts a radial force against it, thereby moving the second bristle carrier 200 in a vertical or radial direction.

As the driveshaft 300 further rotates, the offset 310 ceases its contact with the second bristle carrier 200, thereby permitting the second bristle carrier 200 to return to its original position. In this manner, the second bristle carrier 200 oscillates vertically during powered operation of the toothbrush.

The amplitude of the second bristle carrier's vertical oscillation is dependent upon the radial distance that the offset 310 extends from the longitudinal axis of the driveshaft 300. In yet further embodiments, the second bristle carrier 200 may have a lobe or tab 320 extending radially inwardly from the second bristle carrier 200. In such embodiments, the vertical amplitude of the second bristle carrier 200 depends additionally upon the distance that the tab 320 extends radially inwardly from second bristle carrier 200.

The second bristle carrier 200 should preferably possess sufficient flexibility such that it will move vertically when acted upon by the offset 310 and return to its original position when the vertical force is removed. This may be accomplished by using a generally elastomeric second bristle carrier 200 as described above, or a non-elastomeric (plastic) second bristle carrier 200 having sufficient flexibility. This may also be accomplished if the pivots 207, 212 of the second bristle carrier 200 have sufficient flexibility, e.g., are elastomeric. Preferably, the pivots 207, 212 have sufficient flexibility so that vertical movement of the second bristle carrier does not impart undesirable vertical or shear forces on the first bristle carrier 180, interfere with the sectorial movement of the second bristle carrier 200, or interfere with any other components of the toothbrush 100. Moreover, the driveshaft 300 and offset 310 preferably have sufficient rigidity relative to the second bristle carrier 200 so that neither the driveshaft 300 nor the offset 310 undesirably deflect when in contact with the second bristle carrier 200.

Vertical oscillation of the second bristle carrier 200 imparts additional movement of the bristles against the teeth and/or gums. This further enhances the cleaning and massaging effectiveness of the bristles.

It should also be noted that the embodiment depicted in FIGS. 11-13 illustrates one cam or offset. Thus, the second bristle carrier 200 undergoes one vertical oscillation for every one revolution of the driveshaft 300. Alternatively, the second bristle carrier 200 may undergo additional oscillations per revolution of the driveshaft 300 by configuring the driveshaft 300 with additional cams (not shown). Those skilled in the art will appreciate that any number of cams may be placed on the driveshaft 300 to obtain any desired number of oscillations per driveshaft revolution and how the toothbrush may be configured to achieve such function.

The vertical movement of the second bristle carrier 200 may further be varied by configuring the cams with an uneven pitch around the circumference of the driveshaft 300 and/or by varying the radial offset of the cams from the longitudinal axis of driveshaft 300. For example, if the cams are equally spaced, the second bristle carrier 200 will oscillate at a constant frequency. However, if the cams are not equally spaced, the second bristle carrier 200 will not oscillate at a constant frequency, but rather will oscillate in a complex manner. Similarly, if the radial offset of the cams is varied from one to another, the amplitude of vertical movement of the second bristle carrier 200 may be varied from one oscillation to another. Variations in the vertical movement of the second bristle carrier 200 serve to further vary the movement of the bristles against the teeth and gums.

Referring now to FIGS. 14-16, still other embodiments of the invention include a second bristle carrier 200 that may be suspended from the brush section 104 so as to form a gap 230 between the second bristle carrier 200 and the brush section 104. This may be accomplished by including an indent 215 that is deeper than the thickness of the second bristle carrier 200. Those skilled in the art will appreciate other manners in which the toothbrush components may be adapted to achieve this function. The suspension of the second bristle carrier 200 from the brush section 104 may reduce friction between the two, increasing the smoothness of the toothbrush operation, reducing wear on the components, and reducing power consumption, thereby increasing battery life and/or permitting use of smaller and less expensive drive components.

In order to prevent the possibility of debris, food, toothpaste, saliva and other objects from entering the gap 230, the toothbrush 100 may further include curtains or walls 240 extending from the brush section 104 to the second bristle carrier 200 to generally form a seal over the gap 230. The curtains 240 may alternatively be attached to the second bristle carrier 200. The curtains 240 are preferably sufficiently flexible so as to flex with the sectorial movement of the second bristle carrier 200 and not unduly interfere with its movement. The curtains 240 may be made of elastomeric or non-elastomeric material.

A powered toothbrush made in accordance with the present invention provides a number of advantages over known powered toothbrushes that are presently available. For example, in embodiments having a first bristle carrier that oscillates back and forth, or moves otherwise, the oscillating bristles (i.e., elastomeric and/or non-elastomeric) contact the surfaces of the teeth and the surrounding areas to deliver enhanced cleaning, stimulation, and tooth polishing and/or whitening. Further, embodiments having a second bristle carrier may provide additional bristles that may be disposed in various patterns and combinations different from those of the first bristle carrier. These bristles may move in a different manner than those of the first bristle carrier, which along with the additional number and area of moving bristles, provide increased contact with teeth and gingival tissues for enhanced cleaning and stimulating over known powered toothbrushes.

Although powered toothbrushes of the present invention have been described in terms of the presently preferred embodiments, it is to be understood that such disclosure is not to be interpreted as limiting. It will be understood that various omissions, substitutions, and changes in the form and details of the devices illustrated, and in their operation, may be made by those skilled in the art without departing from the spirit and scope of the invention. Moreover, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. Accordingly, it is intended that the appended claims be interpreted as covering all alterations and modifications that fall within the true spirit and scope of the invention.

What is claimed is:

1. A powered toothbrush having a handle with a neck portion extending from the handle, comprising;
a head connected to the neck portion, said head comprising;
an exposed outer surface;
a first carrier member coupled to the head and operatively connected to a first drive member for moving the first bristle carrier in a defined path of motion, wherein said first bristle carrier has a plurality of tooth care elements extending outwardly from the exposed outer surface; and
a second carrier member being pivotally connected to the first bristle carrier and being pivotally connected to the head so that movement of the first bristle carrier in the defined path of motion is translated into defined movement of the second bristle carrier, wherein said second bristle carrier has a plurality of tooth care elements extending outwardly from the exposed outer surface.

2. The powered toothbrush of claim 1, wherein the first path of motion is about an axis generally perpendicular to the exposed outer surface of the head.

3. The powered toothbrush of claim 1, wherein the first carrier member oscillates in a back and forth manner.

4. The powered toothbrush of claim 1, wherein the first carrier member oscillates in a rotational direction.

5. The powered toothbrush of claim 1, wherein the second carrier member further comprises a body portion and a first pivot that is pivotally connected to the first carrier member and a second pivot that is pivotally connected to the head.

6. The powered toothbrush of claim 5, whereby the first pivot comprises a first protruding member extending from one end of the second bristle carrier and the second pivot comprises a second protruding member extending from another end of the second bristle carrier.

7. The powered toothbrush of claim 6, wherein the first protruding member is received within a first pivot mount formed in the first carrier member and the second protruding member is received within a second pivot mount formed in the head.

8. The powered toothbrush of claim 7, wherein each of the first and second pivot mounts comprises a notch.

9. The powered toothbrush of claim 5, wherein the body portion is formed of first material and the first and second pivots are formed of a second material.

10. The powered toothbrush of claim 5, wherein at least the first and second pivots are formed of an elastomeric material.

11. The powered toothbrush of claim 5, wherein the body portion is free of contact with the first carrier member and the head except at the locations of the first and second pivot mounts.

12. The powered toothbrush of claim 5, wherein the head has an indent portion formed therein and the body portion being disposed above the indent and free of contact therewith.

13. The powered toothbrush of claim 1, wherein the second carrier member is formed of an elastomeric material.

14. The powered toothbrush of claim 1, wherein second carrier member pivots about the first carrier member at a first pivot of the second carrier member and pivots about the head at a second pivot of the second carrier member as the first carrier moves in its said first path of motion.

15. The powered toothbrush of claim 14, wherein the second carrier member moves about an axis which is parallel to the axis of movement of the first carrier member.

16. The powered toothbrush of claim 1, wherein the plurality of tooth care elements of the second carrier member are bristles formed of a material selected from the group consisting of an elastomeric material, a non-elastomeric material, and a combination thereof.

17. The powered toothbrush of claim 1, wherein the second carrier member is operatively connected to a second drive member for moving the second carrier member in a second path of motion.

18. The powered toothbrush of claim 17, wherein the second path of motion is a direction perpendicular to the longitudinal axis of the exposed outer surface of the head.

19. The powered toothbrush of claim 17, wherein the second carrier member vibrates in a vertical direction relative to the exposed outer surface of the head wherein the vibration is due to the second carrier member being operatively connected with the second drive member.

20. The powered toothbrush of claim 17, wherein the second drive member comprises at least one cam surface that is operatively connected with the second carrier member to cause movement of the second carrier member in the second path of motion.

21. The powered toothbrush of claim 20, wherein the at least one cam surface comprises an offset of a driveshaft.

22. The powered toothbrush of claim 17, wherein the lower surface of the second carrier member has a protrusion that is in communication with a cam surface of the second drive member.

23. The powered toothbrush of claim 1, wherein the first drive member comprises a driveshaft that is part of a drive mechanism.

24. The powered toothbrush of claim 1, wherein the second carrier member is disposed above the outer surface of the head so that a gap is formed between the second carrier member and the exposed outer surface of the head, said head further comprising;
a pair of protective curtains extending from the head and being disposed adjacent exterior side faces of the second carrier member so as to seal the gap.

25. The powered toothbrush of claim 24, wherein the curtains are formed of a material that has sufficient resiliency to permit the curtain to flex as the second carrier member moves.

26. A powered toothbrush having a handle with a neck portion extending from the handle, comprising:
a head connected to the neck, the head comprising:
an exposed outer surface;
a first carrier member connected to the head and operatively connected to a first drive member for moving the first carrier member in a first path of motion and said first carrier member having a plurality of tooth care elements extending outwardly therefrom; and
a second carrier member having a body, said body comprising;
a first pivotal connection for connecting the body to the first carrier member;
a second pivotal connection for connecting the body to the head so that movement of the first carrier member in the first path of motion is translated into movement of the second carrier member and the body is free floating except for the connections at the first and second pivotal connections; and
a plurality of tooth care elements extending outwardly from the exposed outer surface.

27. The powered toothbrush of claim 26, wherein the first pivotal connection is a protruding pivot formed at a first end of the body and the second pivotal connection is a protruding pivot formed at a second end of the body.

28. The powered toothbrush of claim 26, wherein each of the first and second carrier members moves about an axis generally perpendicular to the longitudinal axis of the exposed outer surface of the head.

29. A brush section for use in a powered toothbrush, the powered toothbrush having a handle portion including a neck formed at one end, said brush section comprising:
a head connected to the neck, said head comprising;
an exposed outer surface;
a first carrier member connected to the head and operatively connected to a first drive member for moving the first carrier member in a first path of motion wherein the first carrier member has a plurality of tooth care elements extending outwardly from the exposed outer surface;
and a second carrier member being pivotally connected to the first carrier member at one end and being pivotally connected to the head at an opposite end so that movement of the first carrier member in the first path of motion is translated into movement of the second carrier member wherein the second carrier member has a plurality of tooth care elements extending outwardly from the exposed outer surface.

30. The brush section of claim 29, wherein the second carrier member oscillates in accordance with movement of the first carrier member in a sectional manner.
